(19) United States
(12) Patent Application Publication
(10) Pub. No.: US 2009/0091187 A1
(43) Pub. Date: Apr. 9, 2009

(54) Device for Powering a Plurality of Loads from an Electrical Power Supply Network

(75) Inventor: Alain Tardy, Paris (FR)

Correspondence Address: LOWE HAUPTMAN & BERNER, LLP, 1700 DIAGONAL ROAD, SUITE 300, ALEXANDRIA, VA, 22314, US

(73) Assignee: Thales, Neuilly Sur Seine (FR)

(21) Appl. No.: 12/295,769

(22) PCT Filed: Apr. 4, 2007
(86) PCT No.: PCT/EP2007/053295

§ 371 Date: Dec. 10, 2008

(30) Foreign Application Priority Data
Apr. 5, 2006 (FR) 0603002

(51) Int. Cl. H02J 3/14

(52) U.S. Cl. 307/38

(57) ABSTRACT

The invention relates to a device for powering a plurality of loads from an electrical power supply network. The invention is of particular use in the aeronautical domain. The device comprises a number of converters (EPPi) each comprising an input and an output, the input of each converter (EPPi) taking power from the network and the output of each converter (EPPi) being associated with at least one load (Li) to deliver power to it. The device comprises switching means (B1 to B6) enabling the association between converters (EPPi) and loads (Li) to be varied.

The invention relates to a device for powering a plurality of loads from an electrical power supply network. The invention is of particular use in the aeronautical domain. Large air tankers have more and more onboard electrical equipment. Such equipment is of very varied types and the power consumption is extremely variable in time. As an example, the internal air conditioning and lighting systems are in operation almost continuously whereas the redundant safety systems such as the control surface drives are used only occasionally.

Normally, the airplane has a three-phase electrical power supply network able to power all the electrical equipment, hereinafter called loads. The various loads can require different power inputs in terms of voltage and in terms of the nature of the current, AC or DC. Moreover, the loads can be more or less tolerant to the disturbances of the electrical network that powers them. Consequently, the current solution requires each load to be assigned its own converter and its dedicated filtering network. This solution is costly and results in a major onboard weight.

The invention seeks to reduce the weight and the cost of the power transformation devices between an electrical power supply network and the various onboard loads by proposing a modularity of the converters handling the power transformation.

To this end, the subject of the invention is a device for powering a plurality of loads from an electrical power supply network, and a number of converters, each comprising an input and an output, the input of each converter taking the power from the network and the output of each converter being associated with at least one load to deliver power to it, characterized in that it comprises switching means enabling the association between converters and loads to be varied.

The association of the converters and the loads is based on the instantaneous current requirement and the instantaneous control mode of the load (Li) that is associated with it. The load control mode depends mainly on the type of load. Examples commonly implemented in an airplane include speed, torque or position control, anti-icing or de-icing, constant power operation and various engine control strategies (defluxing, control with or without sensor).

The invention will be better understood, and other advantages will become apparent, from reading the detailed description of an embodiment given as an example, the description being illustrated by the appended drawing in which:

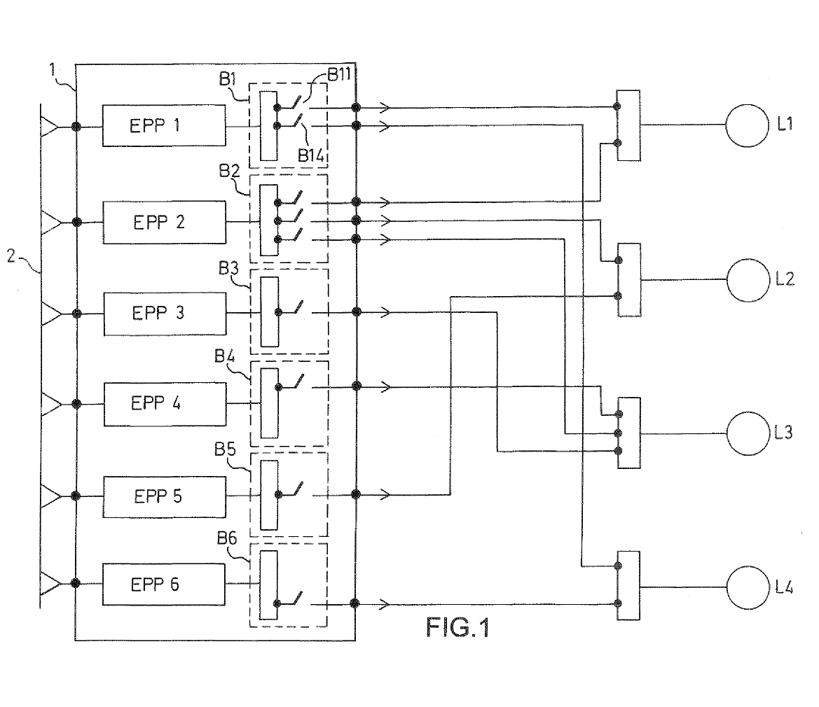

FIG. 1 diagrammatically represents an exemplary device according to the invention;

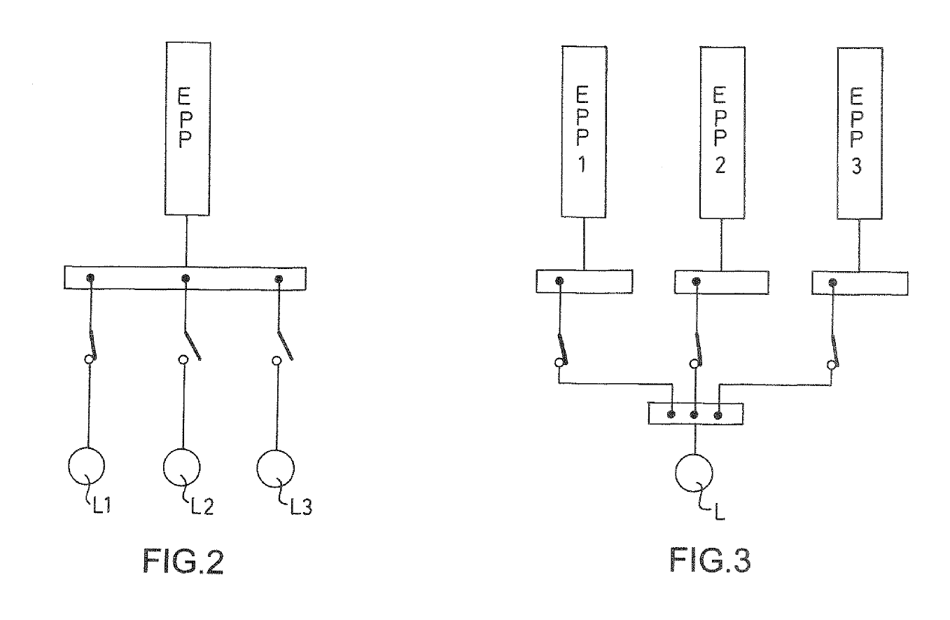

FIG. 2 represents a converter powering only a single load;

FIG. 3 represents a load powered by several converters;

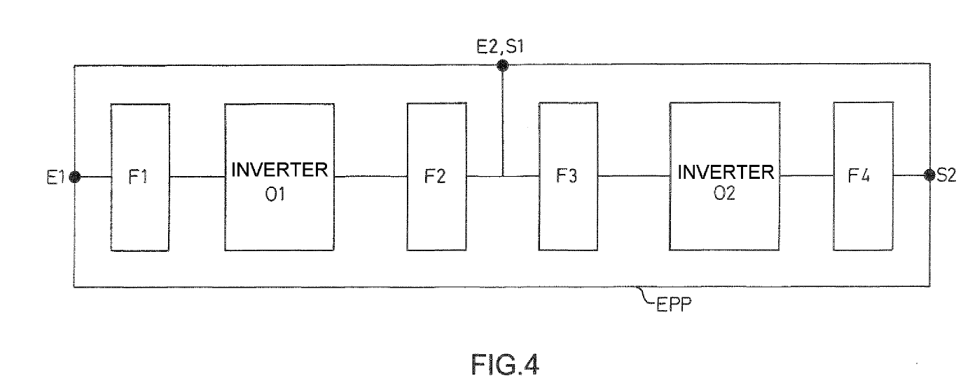

FIG. 4 diagrammatically represents an exemplary converter;

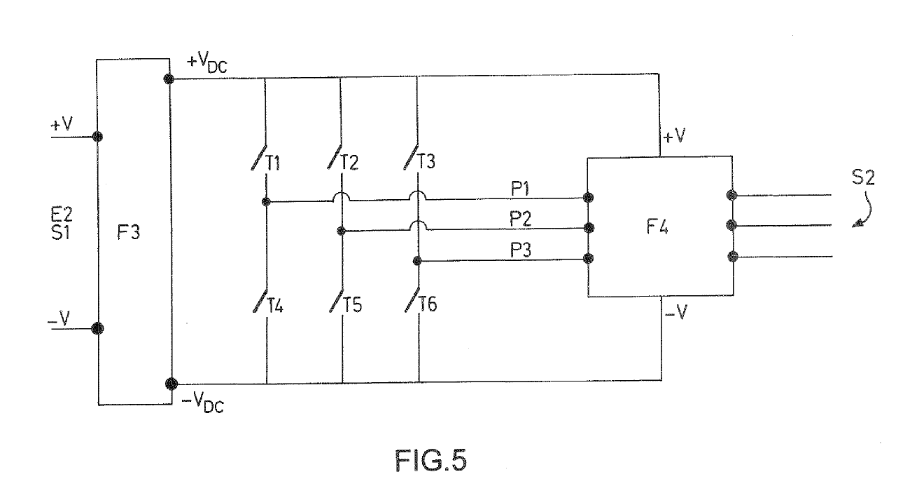

FIG. 5 diagrammatically represents an exemplary inverter comprising an individual voltage inverter, the inverter belonging to the converter represented in FIG. 4;

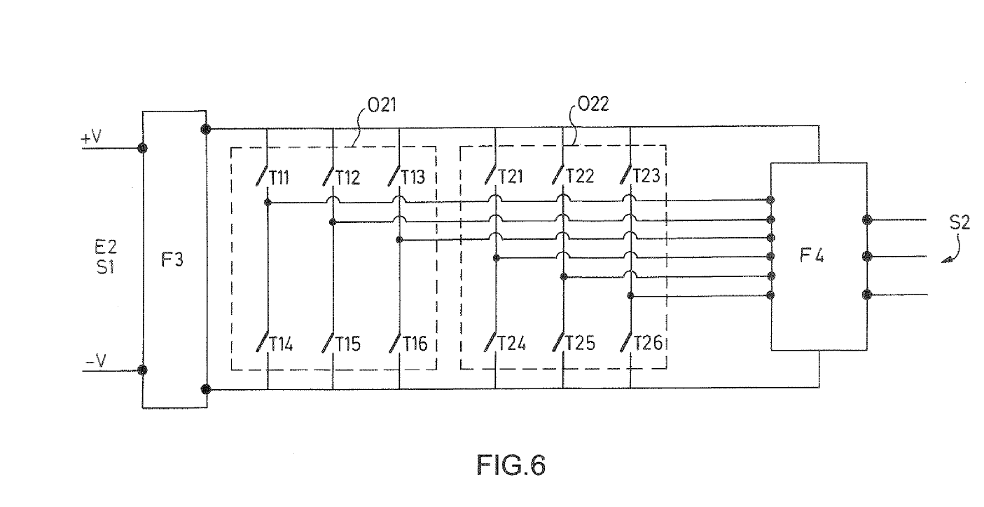

FIG. 6 diagrammatically represents another exemplary inverter comprising two individual voltage inverters;

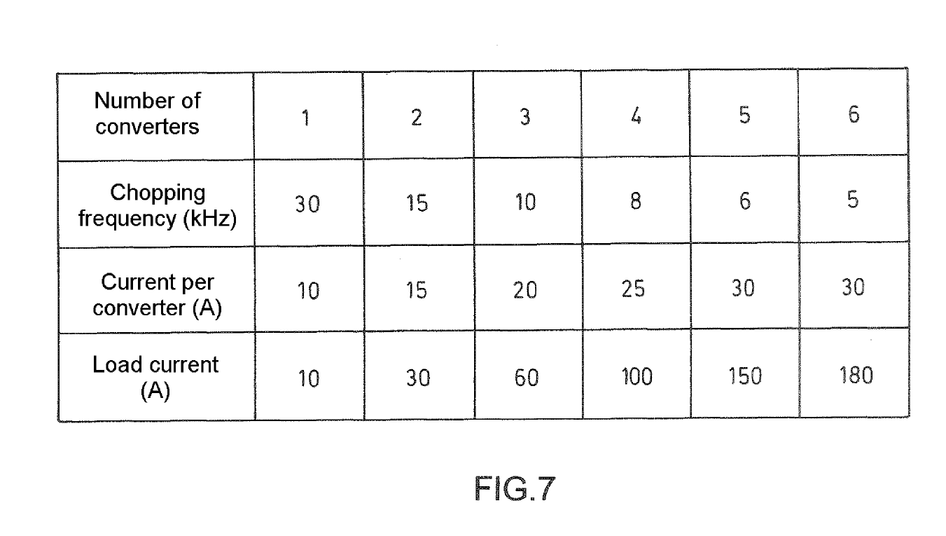

FIG. 7 is a table representing an example of chopping frequencies specific to the converter and converter output currents.

For clarity, the same elements will be given the same identifiers in the various figures.

FIG. 1 represents a device 1 powering several loads used onboard an airplane. In FIG. 1, four loads L1 to L4 are represented as an example. The term “load” will be understood to mean one or more electrical devices permanently powered simultaneously. The device 1 is powered by an AC network 2 with n1 phases. The device delivers to the loads AC voltages with n2 phases. In the most common case, n1=n2=3. It is, of course, possible to implement the invention for a power supply network or for AC voltages with a different number of phases. It is also possible to power the device by means of a DC network and/or to deliver DC voltages to the loads.

The device 1 comprises, for example, six converters EPP1 to EPP6, all powered by the AC network 2. The device 1 also comprises six secondary distribution bars, one for each converter EPP1 to EPP6, respectively B1 to B6. Each secondary distribution bar comprises one or more power switches with n2 phases for powering various loads L1 to L4. In the example represented, the secondary distribution bar B2 can power the load L1 via the switch B11 and the load L4 via the switch B14. Similarly, the secondary distribution bar B2 can power the load L1 via the switch B21, the load L2 via the switch B22 and the load L3 via the switch B23. The secondary distribution bar B3 can power the load L3 via the switch B33. The secondary distribution bar B4 can power the load L3 via the switch B43. The secondary distribution bar B5 can power the load L2 via the switch B52 and the secondary distribution bar B6 can power the load L4 via the switch B64.

Advantageously, the switches are controlled so as to allocate in real time as many converters as are necessary to the power requirement of a given load. The real time allocation or association makes it possible to limit the number of converters in the device 1. The modification of the association in real time can be done for example in the aeronautical domain during a flight. It is, for example, possible, as shown by FIG. 2, to allocate a given converter, identified EPP, to just one of the loads L1, L2 or L3 according to the requirement of each. The three loads L1, L2 and L3 are, for example, each used in different flight phases of the airplane and the converter can be used alternately for one of the three loads L1, L2 or L3.

Another example of allocation is given in FIG. 3. In this example, three converters EPP1, EPP2 and EPP3 are allocated simultaneously to the same load L.

FIG. 4 diagrammatically represents one exemplary converter EPP comprising two inverters O1 and O2 and four filters F1 to F4. The converter EPP can be powered either by an input E1 by means of an AC network or by an input E2 by means of a DC network. The converter EPP can deliver power either in the form of an AC voltage via an output S2 or in the form of a DC voltage via an output S1. The input E1 is linked to the output S1 via the filter F1, the inverter O1 and the filter F2, these three elements being linked in series. The input E2 and the output S1 are combined and are linked to the output S2 via the filter F3, the inverter O2 and the filter F4, these three elements being linked in series. The inverters O1 and O2 can operate in rectifier or alternator mode depending on whether it transforms an AC current into DC current or vice versa. The filters F1 to F4 are, for example, passive filters and comprise inductors and capacitors. To avoid overloading FIG. 4, the number of phases at the input points or output points E1 and S2 are not represented. The inverter O1 could be replaced by a single rectifier or any other means making it possible to transfer power from E1 to E2/S1 or S2. The reversibility of the inverter O2 is not mandatory.

FIG. 5 represents an example of a part of the converter EPP represented in FIG. 4 and implemented with a three-phase voltage at the output S2. More specifically, FIG. 5 diagrammatically represents one exemplary embodiment of the inverter O2 operating on three phases P1, P2 and P3 with six electronic switches T1 to T6. The term “leg” of the inverter O2 is used to denote a set comprising two switches, for example T1 and T4, linked by a common point. In FIG. 5, the inverter O2 comprises two legs. The inverter O2 can comprise one or more additional legs intended to allow an active filtering of the common mode transmitted.

FIG. 6 represents another example in which the inverter comprises two individual three-phase inverters O21 and O22, each using six switches, T11 to T16 for the inverter O21 and T21 to T26 for the inverter O22. The structure shown in FIG. 6 makes it possible to reduce the weight of the filter F4 for one and the same residual ripple level on the output S2.

It is, of course, possible to implement the invention with more than two individual inverters. The carrier frequencies of the different individual inverters are then phase-shifted by 2π/N, with N representing the number of individual inverters. In this case, the individual inverters are interleaved. More specifically, if each individual inverter delivers three phases, these phases will be phase shifted by 2π/3 while retaining a phase shift of the carrier frequencies of the various individual converters between them of 2π/N.

FIG. 7 is a table representing an example of chopping frequencies specific to the converter and converter output currents powering only a single load Li. The first line of the table shows the number of converters that can power the load Li via their secondary distribution bar Bi. In other words, each secondary distribution bar Bi comprises a switch Bii that can power the load Li. The switches Bii are open or closed according to the current requirement of the load Li.

Advantageously, each converter EPPi receives a current setpoint to be delivered to the load or loads Li that are associated with it. This current setpoint depends on the requirement of the load and on the various associated converters. The device comprises a computer centralizing the current requirements of the various loads and the availability state of the various converters. The computer determines the current setpoint sent to the various converters.

The current consumed by the load Li is given in the fourth line of the table and is expressed in amperes. The example has been limited to six converters, but it is, of course, possible to extend the example to a larger number of converters. The current delivered by each converter is given in the third line of the table and is also expressed in amperes. This current is equal to the current consumed by the load Li divided by the number of converters connected to the load Li. It is assumed that a converter can deliver a maximum of 30 A. To power a load consuming 30 A, it is possible to power it only by a single converter or to power it by two converters each delivering only 15 A as illustrated by the second column of the table. Other possibilities are of course feasible, and the possibility is chosen according to the number of converters available at the given time even if it means compromising this choice subsequently. In practice, if a load requires a current that falls between two columns of the table, the configuration corresponding to the next higher ranking column can be chosen.

The example illustrated in FIG. 7 gives the actual currents consumed by a load. It is of course possible to have the current varied instantaneously during a period according to the instantaneous current requirement in terms of quantity and quality of waveform required by the load.

Advantageously, each converter EPPi operates in pulse-width modulation mode and the device comprises means for adapting in real time a chopping frequency specific to the converter according to the instantaneous power requirement and the instantaneous control mode of the load Li that is associated with it. In other words, the current setpoint modifies a chopping frequency of the converter receiving this setpoint. This frequency is given in the table in the second line and is expressed in kilohertz. In order to keep a substantially constant level of disturbance on the output voltage of each converter, a chopping frequency f1 is chosen for a single converter powering the load Li, 30 kHz in the example chosen, and the frequency retained for n converters is equal to f1/n.

Advantageously, the device comprises means for adapting in real time a chopping clock phase specific to the converter according to the instantaneous power requirement of the load Li that is associated with it. This phase makes it possible to adapt in real time the current delivered by the converter as required by the load Li. Adapting the clock phase is mainly of interest in the case where at least two converters are associated with one and the same load. The adaptation is done on one converter relative to the other.

Advantageously, and more generally, the device comprises means for adapting in real time a vector control of the converter or converters associated with a load. It is possible, for example, to change from a vector control of type X to a vector control of type Y according to the instantaneous power requirement and the control mode of the load Li that is associated with it. This phase makes it possible to adapt in real time the current delivered by the converter to the requirement of the load Li while limiting the level of the disturbances on the load's power supply.

The vector control comprises in particular the vector pattern in a cycle, in other words, the sequence of voltage vectors applied to the load during an operating cycle, the frequency of the patterns, the type of modulator, for example with pulse-width modulation, and the phase of a clock of the cycle. The vector control is established using the order of opening and closing of the switches.

It is also possible to modify the type of converter modulation. The notion of “modulation type” should be understood, for example, to mean the act of using a triangular clock and the act of triggering a pulse on the rising or falling edges of the clock. In critical cases, it is also possible to modify a protection mode parameterizing of the converter. It is possible, for example, to allow a converter to deliver a current greater than its rated current for a short period or even for an unlimited time by accepting a possible failure of the converter in order to power a critical load such as, for example, the control surfaces of an airplane in the landing phase. In the event of failure of a converter, the load can be allocated to another converter.

The device can manage the case where all the converters are used and where at a given instant an additional load needs to be powered. A priority level is assigned to each load. For example, in an airplane, the flight controls will have a priority level that is higher than the power supply for a video system used to show films to the passengers. The device then comprises means for suspending the power supply to a load with a low priority level, when all the converters are used to power the loads with a higher priority level. In our example, the device can suspend the power supply to the video system in favor of the flight controls when necessary. The means for suspending the power supply to a load make it possible to improve the availability rate of a critical load without permanently assigning it several converters necessary only for their own redundancy.

The priority levels of the various loads can, for example, be stored in an allocation table belonging to the device 1. This table for allocating converters and loads can vary according to the phases of the mission of the airplane, according to the critical nature and availability levels of the loads and according to the number of converters available. This table makes it possible to determine the position of the various switches Bii throughout the mission.

1. A device for powering a plurality of loads from an electrical power supply network, and a number of converters, each having an input and an output, the input of each converter taking power from the network and the output of each converter being associated with at least one load to deliver power to the at least one load wherein said devices comprises switches controlled so at to allocate in real time as many converters as necessary to the power requirement of a give load.

2. The device as claimed in claim 1, wherein said device comprises a computer centralizing the current requirements of the various loads and the availability state of the various converters the computer determining the current setpoint sent to the various converters.

3. The device as claimed in claim 1, wherein each converter receives a current setpoint to be delivered to the load or loads that are associated with said device.

4. The device as claimed in claim 3, wherein each converter operates in pulse-width modulation mode and in that the current setpoint modifies a chopping frequency of the converter.

5. The device as claimed in claim 3, wherein each converter operates in pulse-width modulation mode and in that the device comprises means for adapting a clock phase of one converter relative to the other.

6. The device as claimed in claim 3, wherein each converter operates in pulse-width modulation mode and in that the device comprises means for modifying a vector control of the converter.

7. The device as claimed in claim 3, wherein each converter operates in pulse-width modulation mode and in that the current setpoint modifies the modulation type of the converter (EPPI).

8. The device as claimed in claim 3, wherein the current setpoint modifies a protection mode parameterizing of the converter.

9. The device as claimed in claim 1, wherein the loads (Li) each have a priority level, and in that the switches can be used to suspend the power supply to a load of a low-priority level, when all the converters are used to power the high level loads.

10. The device as claimed in claim 1, wherein each converter comprises a number of individual conversion modules and wherein the individual conversion modules are interleaved, the interleaving mode depending on the vector control used.

11. The device as claimed in claim 1, wherein said device comprises means for adapting in real time a chopping frequency specific to the converter according to the instantaneous power requirement and the instantaneous control mode of the load that is associated with it.

12. The device as claimed in claim 1, wherein said device comprises means for adapting in real time a chopping phase specific to the converter according to the instantaneous power requirement and the instantaneous control mode of the load associated with it.

13. The device as claimed in claim 1, wherein said device comprises means for adapting in real time a vector control specific to the converter according to the instantaneous power requirement and the instantaneous control mode of the load (Li) that is associated with it.

14. The device as claimed in claim 1, wherein the device comprises means for allocating at least one load to another converter in the event of a failure of a currently used converter.

15. The device as claimed in claim 3, wherein the loads each have a priority level, and in that the switching means can be used to suspend the power supply to a load of a low-priority level, when all the converters are used to power the high level loads.

16. The device as claimed in claim 2, wherein each converter comprises a number of individual conversion modules and in that the individual conversion modules are interleaved, the interleaving mode depending on the vector control used.

17. The device as claimed in claim 3, wherein each converter comprises a number of individual conversion modules and in that the individual conversion modules are interleaved, the interleaving mode depending on the vector control used.

18. The device as claimed in claim 2, wherein the loads each have a priority level, and in that the switching means suspend the power supply to a load of a low-priority level, when all the converters are used to power high level loads.
